(19) United States
(12) Patent Application Publication
(10) Pub. No.: US 2003/0049521 A1
(43) Pub. Date: Mar. 13, 2003

(54) Lead acid battery

(75) Inventors: Shinji Iwase, Kyoto (JP); Tetsuro Minato, Kyoto (JP)

Correspondence Address: SUGHRUE MION, PLLC, 2100 PENNSYLVANIA AVENUE, N.W., WASHINGTON, DC, 20037, US

(73) Assignee: JAPAN STORAGE BATTERY CO., LTD.

(21) Appl. No.: 10/234,164

(22) Filed: Sep. 5, 2002

(30) Foreign Application Priority Data
Sep. 11, 2001 (JP) P. 2001-274995

(51) Int. Cl. H01M 2/12; H01M 2/02

(52) U.S. Cl. 429/82; 429/55; 429/175

(57) ABSTRACT

A lead acid battery comprising: a container; a cover including an exhaust port; and a projection disposed in a peripheral portion of the exhaust port, wherein the exhaust port is formed in an upper surface or a side surface of the cover.

### BACKGROUND OF THE INVENTION

The present invention relates to a lead acid battery which is capable of effectively discharging gas occurring in the interior of the lead acid battery to the exterior thereof.

As a secondary battery which is carried on board a vehicle or a vessel, there is used a lead acid battery. In the lead acid battery, in case where an overcharge occurs, water, which is an electrolyte, electrolyses to generate hydrogen gas and oxygen gas. In case where the gas is left as it is, the internal pressure of the lead acid battery rises, with the result that a container is expanded to thereby lower the performance of the lead acid battery. In the worst case, there is a fear that the lead acid battery can be broken. For this reason, the gas must be discharged out from the interior of the lead acid battery. In the case of a lead acid battery with a control valve, in the cover portion thereof, there are disposed a control valve and an exhaust port. In case where gas is generated in the interior of the lead acid battery and the internal pressure thereof is thereby caused to rise up to a given level of pressure or higher, the control valve is opened, so that the electrolyte is prevented against leakage to the exterior of the lead acid battery but only the gas can be discharged from the interior of the lead acid battery to the exterior thereof.

Now, FIG. 9 shows a longitudinal section view of an example of a conventional lead acid battery with a control valve. In the interior of a container 21, there are stored active material and electrolyte (both of which are not shown) which are used as electricity generating elements. The top portion of the container 21 is covered with an inner lid 22 and is sealed by heat deposition so as to prevent the electrolyte against leakage from the interior of the lead acid battery. In the middle portion of the inner lid 22, there is formed a cavity portion 24. In the cavity portion 24, there is mounted a rubber-made control valve 25 in such a manner that it covers a cylindrical-shaped opening 12 formed in the cavity portion 24. The control valve 25 operates in the following manner: that is, in case where the lead acid battery is overcharged to thereby generate gas in the interior of the lead acid battery and the internal pressure of the lead acid battery is thereby caused to rise, the control valve 25 is opened to discharge the gas generated in the interior of the lead acid battery therefrom to thereby adjust the internal pressure of the lead acid battery. Also, the upper lid 23 of the cavity 24 is heat deposited or ultrasonically deposited in order to protect the control valve 25 that is made of rubber. Further, in the upper lid 23, there is opened up an exhaust port 26 which is used to exhaust the gas, which is discharged from the control valve 25, from the cavity portion 24.

As shown in FIG. 10, when carrying a lead acid battery 1 on board a vehicle, the lead acid battery 1 is placed on a tray 27 and an iron plate 28a (which is a fixing metal member 28) is then held using two bolts 28b to thereby fix the lead acid battery 1 to the tray 27 from above. In this case, the iron plate 28a is fixed in such a manner that it extends over the central portion of the upper lid 23 provided with the exhaust port 26. In some cases, in order to ease slight vibrations caused by an engine or due to the running operation of the vehicle to prevent the lead acid battery 1 from being shifted on the tray 27 to thereby prevent the fixing metal member 28 from damaging the lead acid battery 1, between the upper portion or side surface of the lead acid battery 1 placed on the upper surface of the tray 27 and the fixing metal member 28, there is inserted a elastic sheet 29 such as a rubber sheet. Also, in the case of a small-sized lead acid battery to be carried on board a motor cycle, instead of the fixing metal member, a rubber band may be used to fix the lead acid battery to the tray.

The fixing metal member 28 for carrying a lead acid battery on board a vehicle or a motor cycle is formed in various shapes according to the kinds of vehicles on board which the lead acid battery is to be carried. That is, as in the above-described cases, the fixing metal member 28 may be used to hold the lead acid battery 1 from above or may be used to hold the lead acid battery 1 from the side surfaces thereof; and the fixing position of the lead acid battery 1 varies according to cases. For these reasons, there arise the following possibilities: that is, the sheet 29 used to fix the lead acid battery 1 can spread over the exhaust port 26; even when the sheet 29 is not used, the iron plate 28a used in the fixing metal member 28 can cover the exhaust port 26; and, even in case where the lead acid battery 1 is fixed using the rubber band, the rubber band can cover the exhaust port 26. Therefore, there is found a problem that, in the case of a lead acid battery with a control valve, even in case where the control valve 25 is operated, the gas generated in the interior of the lead acid battery 1 cannot be exhausted to the exterior of the lead acid battery 1. In case where the gas collects in the interior of the lead acid battery 1, the container 21 swells, which gives rise to the lowered performance of the lead acid battery 1 and, in the worst case, which causes the lead acid battery 1 to break. To improve the exhaust of the gas, the diameter of the exhaust port 26 may be increased or the number of exhaust ports 26 may be increased. However, in case where the exhaust port 26 is increased in diameter or in number excessively, dust or water can enter the interior of the exhaust port 26, which, in the case of a lead acid battery with a control valve, has an ill influence on the operation of the control valve 25 or can damage a filter. On the other hand, the component of the gas to be exhausted consists mainly of a mixture of hydrogen and oxygen and, in case where sparks enter the interior of the lead acid battery from the exhaust port 26, there is a fear that the gas collecting in the interior of the lead acid battery can explode.

### SUMMARY OF THE INVENTION

The present invention aims at eliminating the above-mentioned drawbacks found in the conventional lead acid battery. Accordingly, it is an object of the present invention to provide a lead acid battery which, even in case where an exhaust port is covered with a sheet having no ventilation while the lead acid battery is being charged or discharged, is surely able to exhaust gas from the interior of the lead acid battery to the exterior thereof.

In a first aspect of the present invention, a lead acid battery comprising: a container; a cover including an exhaust port; and a projection disposed in a peripheral portion of the exhaust port, wherein the exhaust port is formed in an upper surface or a side surface of the cover. In addition, it is preferable that the lead acid battery as set forth in the first aspect, wherein the cover comprises: an inner lid having a control valve unit; and, an upper lid covering the control valve unit, wherein the control valve unit is disposed on a top surface or side surface of the inner lid and, the projection is disposed in the peripheral portion of the exhaust port. In addition to this, it is preferable that the lead acid battery as set forth in the above construction, wherein the surface of the inner lid adjoining the upper lid forms a first groove therein by cooperating with the upper lid, and the exhaust port is formed in the first groove.

According to the first aspect of the present invention, since the projection is formed in the peripheral portion of the exhaust port, even in case where the exhaust port is covered with a sheet having no ventilation such as a rubber sheet, there is formed a space between the exhaust port and sheet, the gas exhaust port is not closed and thus the gas can be exhausted to the exterior of the lead acid battery.

In a second aspect of the present invention, a lead acid battery as set forth in the first aspect, wherein the projection includes a plurality of projections, the mutually adjoining ones thereof defining a recessed portion therebetween, and the exhaust port is formed in the recessed portion.

According to the second aspect of the present invention, because the exhaust port is opened up in the valley portion defined by and between the projections, even in case where the exhaust port is covered with a sheet having no ventilation such as a rubber sheet, the sheet is prevented from being closely contacted with the exhaust port and, due to the valley portion, there is formed a space between the exhaust port and sheet, so that the gas can be exhausted positively. Also, in case where the valley portion has a length that allows the valley portion to extend outwardly of the sheet, the present space can serve as an exhaust passage for the gas exhausted, which makes it possible to exhaust the gas to the exterior of the lead acid battery positively.

In a third aspect of the present invention, The lead acid battery as set forth in the first aspect, wherein the exhaust port and a first groove continuously connected with the exhaust port are formed in the cover, the first groove is formed in the top surface or side surface of the cover, and the exhaust port is formed in the first groove.

According to the third aspect of the present invention, even in case where the exhaust port is covered with a sheet having no ventilation such as a rubber sheet, the sheet is prevented from being closely contacted with the exhaust port, and gas exhausted is allowed to flow through the groove up to a portion which is not covered with the sheet, thereby being able to exhaust the gas to the exterior of the lead acid battery positively.

In a fourth aspect of the present invention, the lead acid battery as set forth in the first aspect, wherein a groove is formed so as to adjoin the projection. In addition, it is preferable that the lead acid battery as set forth in the second aspect, wherein a groove is formed so as to adjoin the projections.

According to the fourth aspect of the present invention, even in case where the exhaust port is covered with a sheet having no ventilation such as a rubber sheet, since there is formed a clearance between the sheet and exhaust port, the gas exhausted is allowed to flow into the clearance, so that the gas can be exhausted positively through the groove formed in the peripheral portion of the projection to the exterior of the lead acid battery.

In a fifth aspect of the present invention, the lead acid battery as set forth in the third aspect, wherein, a second groove is formed in the cover so as to intersect the first groove. In addition, it is preferable that the lead acid battery as set forth in fifth aspect, wherein at least one end of the second groove reaches the end face of the cover.

According to the fifth aspect of the present invention, since there is formed a second groove intersecting the first groove with an exhaust port opened up therein, even in case where the sheet covers a wide range, an exhaust passage for the gas can be secured, so that the gas can be exhausted positively to the exterior of the lead acid battery.

In the present invention it is also preferable that the lead acid battery comprising: a container; and, a cover including an exhaust port, wherein a first groove continuously connected with the exhaust port is formed in the top surface or side surface of the cover and the exhaust port is formed in the first groove. In addition it is preferable that the lead acid battery as set forth in the above construction, wherein the cover comprises: an inner lid having a control valve unit; and, an upper lid covering the control valve unit, wherein the surface of the inner lid adjoining the upper lid is formed the first groove therein by cooperating with the upper lid, and the exhaust port is formed in the first groove. In this construction, the exhaust port is formed at an upper surface of the upper lid generally. However, the exhaust port may be formed at a side surface of the inner lid.

### BRIEF DESCRIPTION OF THE DRAWINGS

FIG. 1 is a perspective view of the whole of a lead acid battery according to a first embodiment of the present invention, in which a projection is formed in the peripheral portion of an exhaust port;

FIG. 2 is a partially enlarged longitudinal section view of the neighboring portion of the exhaust port of the lead acid battery according to the first embodiment of the present invention, showing an example of use of the present lead acid battery when the top surface of the lead acid battery is covered with a sheet;

FIG. 3 is a perspective view of the whole of a lead acid battery according to a second embodiment of the present invention, in which an exhaust port is opened up in a valley portion defined by and between two projections;

FIG. 4 is a perspective view of the whole of a lead acid battery according to a third embodiment of the present invention, in which an exhaust port is opened up in a valley portion defined between two projections and, in the periphery of the projections, there is formed a groove;

FIG. 5 is a perspective view of the whole of a lead acid battery according to a fourth embodiment of the present invention, in which an exhaust port is opened up in a first groove and there is formed a second groove so as to intersect the first groove;

FIG. 6 is a perspective view of the whole of a lead acid battery according to a fifth embodiment of the present invention, in which an exhaust port is opened up in a first groove, there is formed a second groove so as to intersect the first groove, and the second groove is formed so as to extend up to a side constituting the top surface of the lead acid battery;

FIG. 7 is a perspective view of the whole of a lead acid battery according to a sixth embodiment of the present invention, in which a groove and a exhaust port formed in the groove are defined in the side surface of the lead acid battery;

FIGS. 8A to 8C are partially enlarged longitudinal section views of the neighboring portion of the exhaust port of the lead acid battery according to the sixth embodiment of the present invention;

FIG. 9 is a longitudinal section view of a conventional lead acid battery; and,

FIG. 10 is a perspective view of the conventional lead acid battery, showing an example of fixation of the lead acid battery when it is carried on board a vehicle.

### DETAILED DESCRIPTION OF THE PREFERRED EMBODIMENTS

Now, description will be given below of the specific embodiments of a lead acid battery according to the present invention with reference to the accompanying drawings. By the way, in order to avoid use of different designations for the same elements, the same composing elements of the respective embodiments as the previously described conventional lead acid battery will be described using the same designations.

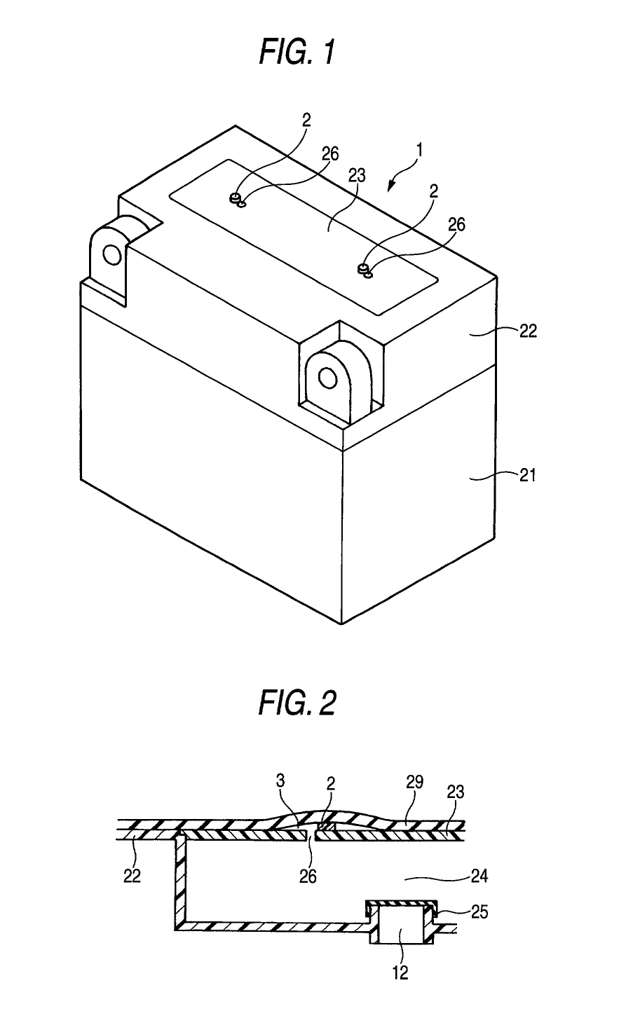

FIG. 1 shows a first embodiment of a lead acid battery according to the present invention and, specifically, FIG. 1 is a perspective view of the whole of the present lead acid battery in which a projection is formed in the peripheral portion of an exhaust port. And, FIG. 2 is a partially enlarged longitudinal section view of the neighboring portion of the exhaust port of the lead acid battery in which a projection is formed in the peripheral portion of the exhaust port according to the first embodiment of the present invention, showing a state thereof when the top surface of the lead acid battery is covered with a rubber sheet. The present lead acid battery 1, as has been shown in the conventional lead acid battery, comprises a container 21 in which electricity generating elements are stored, an inner lid 22 including therein a control valve unit. In the case of a lead acid battery with a control valve, the present lead acid battery 1 comprises an upper lid 23 which is used to protect a control valve 25 and also in which there is formed a penetration hole serving as an exhaust port 26. In the upper lid 23, there are formed projections 2, 2 at given intervals and, in the neighboring portions of the projections 2, 2, there are formed exhaust ports 26, 26, respectively. When the exhaust ports 26, 26 are covered with a sheet 29 for prevention of vibrations or with a fixing metal member 28 for fixing the lead acid battery (for both of them, see FIG. 10) as shown in FIG. 2, due to the projections 2, the sheet 29 is prevented from being closely contacted with the exhaust port 26, so that, between the exhaust sheet 26 and sheet 29, there can be formed a space 3.

That is, since the control valve 25 is opened due to the high-pressure gas, the gas discharged to the cavity portion 24 is then exhausted from the exhaust port 26 to the space 3 which is present in the exterior of the lead acid battery 1 and flows through between the sheet 29 and lead acid battery 1. Therefore, the high-pressure gas is positively discharged to the exterior of the lead acid battery 1 with no trouble. By the way, the projection 2 may only have shape that, when the projection 2 is covered by the sheet, can form the above space and allows the gas to be discharged through the space; and, therefore, the shape and size of the projection 2 can be decided arbitrarily according to the material of the sheet.

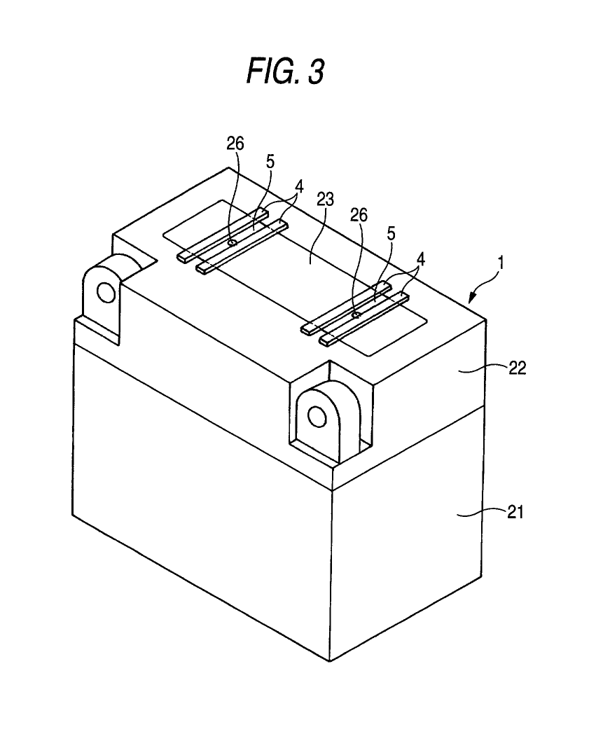

Now, FIG. 3 shows a second embodiment of a lead acid battery according to the present invention and, specifically, FIG. 3 is a perspective view of the whole of the present lead acid battery in which there is opened up an exhaust port in a valley portion formed by and between two mutually opposing projections. The present lead acid battery 1, as has been shown in the conventional lead acid battery, comprises a container 21 in which electricity generating elements are stored, an inner lid 22 including therein a control valve unit. In the case of a lead acid battery with a control valve, the present lead acid battery 1 comprises an upper lid 23 which is used to protect a control valve 25 and also in which there is formed a penetration hole serving as an exhaust port 26. And, on the top surface of the lead acid battery 1, there are disposed two mutually opposing projections 4 and, between these two projections 4, there is formed a valley portion 5. And, in the valley portion 5, there is formed an exhaust port 26 through which gas generated in the interior of the container 21 can be discharged therefrom.

Therefore, even in case where the vibration preventive sheet 29 or fixing metal member 28 for fixing the lead acid battery (for both of them, see FIG. 10) spreads over the exhaust port 26, there is formed a space between the exhaust port 26 and sheet 29 or fixing metal member 28 due to the projections 4, 4, which allows the gas to be exhausted. Also, the valley portion 5 defined by and between the projections 4, 4 provides an exhaust passage for the gas, so that the gas can be exhausted up to a portion which is not covered with the sheet 29. In the present embodiment, the two projections 4 are composed of two long and narrow rectangular members. However, since the projections 4 may only have function that, when the sheet 29 or fixing metal member 28 spreads over the exhaust port 26, can form the above space and allows the gas to be discharged through the space, the shape and size of the projection 4 can be decided arbitrarily according to the shape and fixing location of the fixing metal member 28 as well as the material and size of the sheet 29, while the number of the projections 4 may be at least two. Alternatively, by extending the length of the projection 4 up to a side which constitutes the top surface of the lead acid battery 1, the gas can be discharged from the side surface of the lead acid battery 1 even when the entire top surface of the lead acid battery 1 is covered with the sheet.

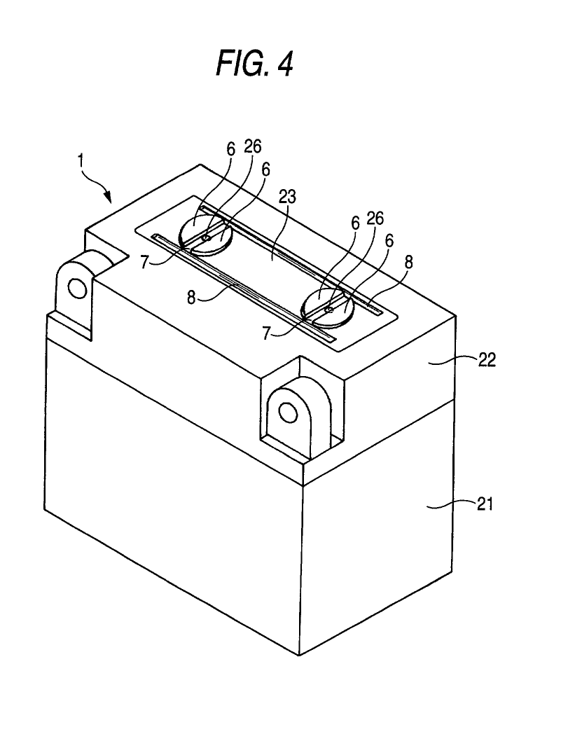

Now, FIG. 4 shows a third embodiment of a lead acid battery according to the present invention. Specifically, FIG. 4 is a perspective view of the whole of the present lead acid battery in which an exhaust port is opened up in a valley portion defined by and between two mutually opposing projections. In the periphery of the two projections, there is formed a groove. The present lead acid battery 1, as has been shown in the conventional lead acid battery, comprises a container 21 in which electricity generating elements are stored, an inner lid 22 including therein a control valve unit. In the case of a lead acid battery with a control valve, the present lead acid battery 1 comprises an upper lid 23 which is used to protect a control valve 25 and also in which there is formed a penetration hole serving as an exhaust port 26. And, on the top surface of the lead acid battery 1, there are disposed two mutually opposing projections 6, there is opened up an exhaust port 26 in a valley portion 7 formed by and between these two projections 6, and, in the cut portion of the valley portion 7, there is formed a groove 8.

According to the present structure, even in case where the exhaust port 26 is covered with the sheet 29 or fixing metal member 28 (for both of them, see FIG. 10), gas exhausted from the exhaust port 26 can be discharged to a space formed between the exhaust port 26 and sheet 29 and thus the gas can be exhausted through the groove 8 up to a portion which is not covered with the sheet 29. Since the exhaust direction of an exhaust passage defined by the valley portion 7 formed by and between the projections 6 is different from the exhaust direction of the groove 8, the gas can be exhausted effectively when the exhaust port 26 is covered over a wide area thereof.

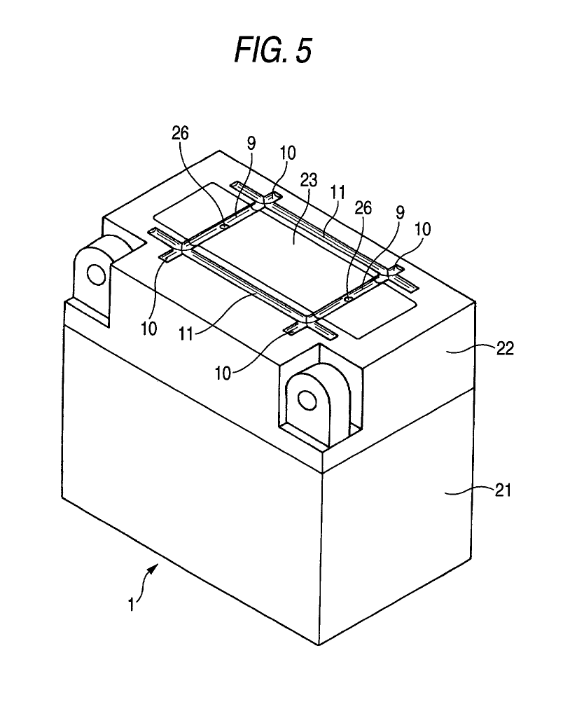

Now, FIG. 5 shows a fourth embodiment of a lead acid battery according to the present invention. Specifically, FIG. 5 is a perspective view of the whole of the lead acid battery, in which an exhaust port is opened up in a first groove and there is formed a second groove so as to intersect the first groove. The present lead acid battery 1, as has been shown in the conventional lead acid battery, comprises a container 21 in which electricity generating elements are stored, an inner lid 22 including therein a control valve unit. In the case of a lead acid battery with a control valve, the present lead acid battery 1 comprises an upper lid 23 which is used to protect a control valve 25 and also in which there is formed a penetration hole serving as an exhaust port 26. In the top surface of the upper lid 23, there are formed two grooves 9 and, in each of the grooves 9, there is opened up an exhaust port 26. Also, in the top surface of the inner lid 22 into which the top lid 23 is fitted, there are formed grooves (first grooves) 10, 10 which are connected with the grooves 9 (first grooves) and grooves (second grooves) 11, 11 which respectively intersect their associated first grooves 10, 10.

In the present embodiment as well, even in case where the exhaust port 26 is covered with the sheet 29 or fixing metal member 28 (for both of them, see FIG. 10), since the exhaust port 26 lies in the groove, the sheet 29 or fixing metal member 28 is prevented from being closely contacted with the exhaust port 26, while the gas exhausted from the exhaust port 26 can be discharged through the grooves 9, 10 up to a portion which is not covered with the sheet. Even in case the sheet spreads over the entire areas of the grooves 9, 10, the gas flows to the grooves 11, 11 extending so as to intersect the grooves 9, 10. Therefore, even in case where the sheet covers a wide range of the upper lid, the gas can be exhausted effectively. By the way, in case where the grooves 10 and/or grooves 11 are formed so as to extend up to sides which constitute the top surface of the lead acid battery, even when the entire top surface of the lead acid battery is covered with the sheet, the gas can be exhausted from the side surfaces of the lead acid battery.

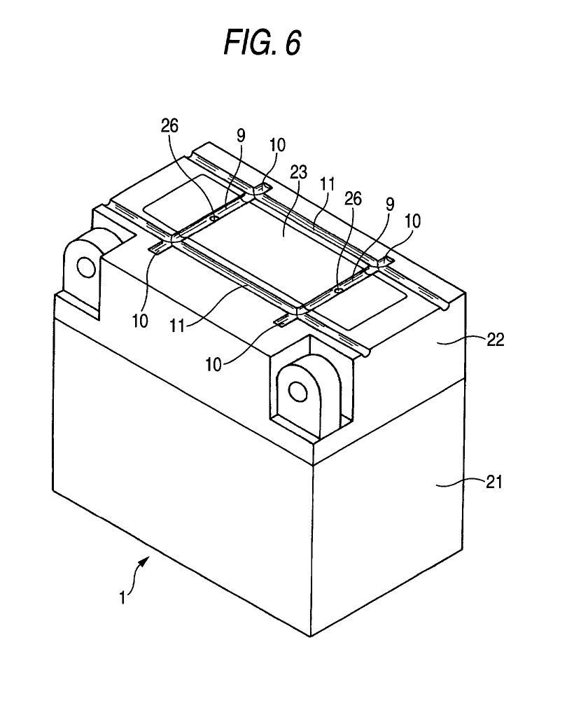

Now, FIG. 6 shows a fifth embodiment of a lead acid battery according to the present invention. Specifically, FIG. 6 is a perspective view of the whole of the present lead acid battery, in which an exhaust port is opened up in a first groove, there is formed a second groove so as to intersect the first groove, and the second groove is formed so as to extend up to a side constituting the top surface of the lead acid battery. In other words, the fifth embodiment is a modification of the fourth embodiment shown in FIG. 5 and is characterized in that the grooves 11 intersecting the grooves 10 at right angles are formed so as to extend up to sides which constitute the top surface of the inner lid 22. By the way, the remaining portions of the fifth embodiment are similar in structure to those of the previously described fourth embodiment.

In the above structured lead acid battery, even in case where the entire upper surfaces of the upper lid 23 and inner lid 22 are covered with the sheet 29 or fixing metal member 28, the gas exhausted from the exhaust port 26 can be exhausted through the grooves 11 to the exterior of the lead acid battery from the side surfaces of the inner lid 22 effectively.

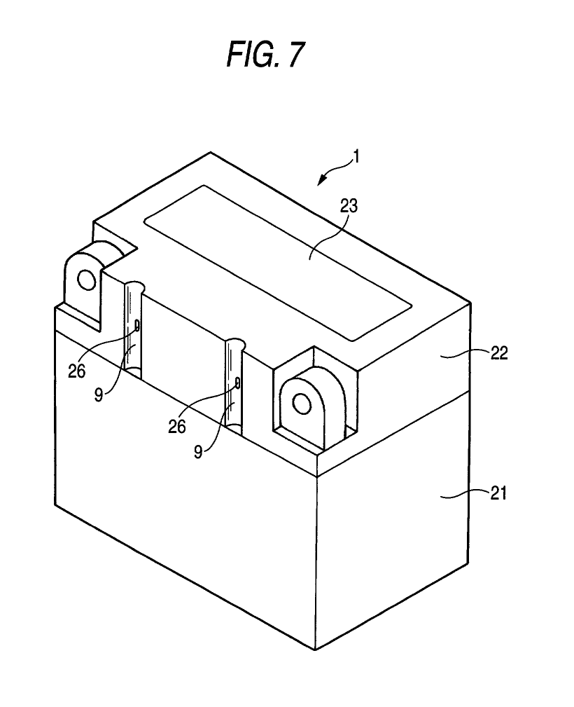

FIG. 7 shows a sixth embodiment of a lead acid battery according to the present invention. Specifically, FIG. 7 is a perspective view of the whole of the present lead acid battery, in which a groove and a exhaust port formed in the groove are defined in a side surface of the lead acid battery. Two grooves are formed on the side surface of the inner lid 22 and parallel to each other in a vertical direction of the lead acid battery 1. In addition, two exhaust ports are respectively formed in the grooves. The sixth embodiment is a modification of the fifth embodiment shown in FIG. 6. By the way, the remaining portions of the sixth embodiment are similar in structure to those of the previously described fifth embodiment.

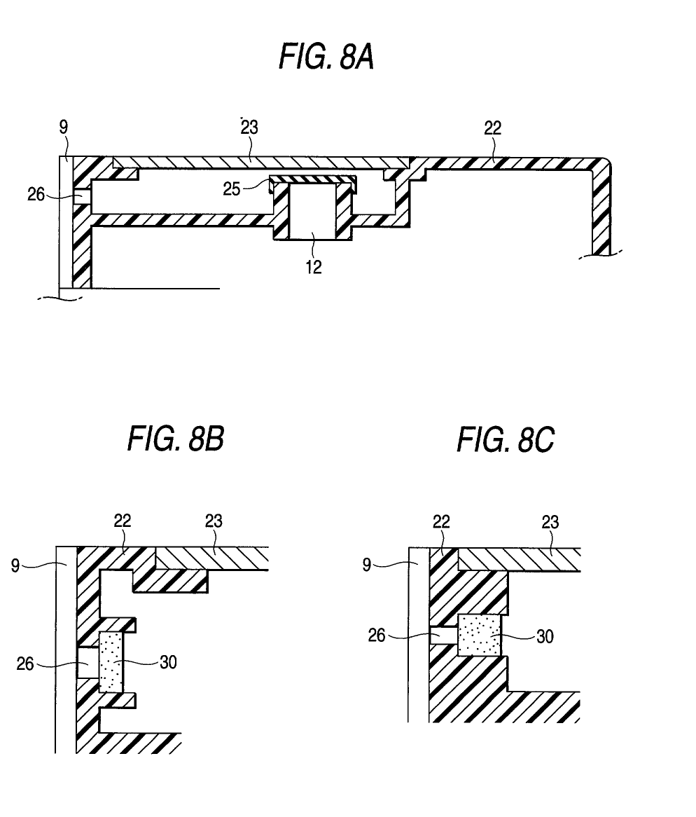

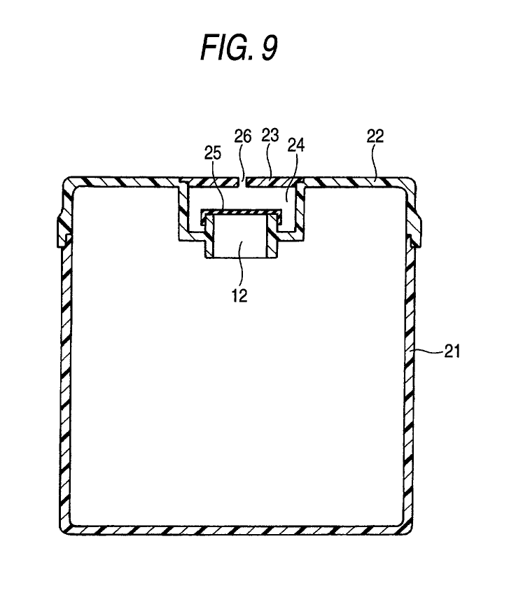

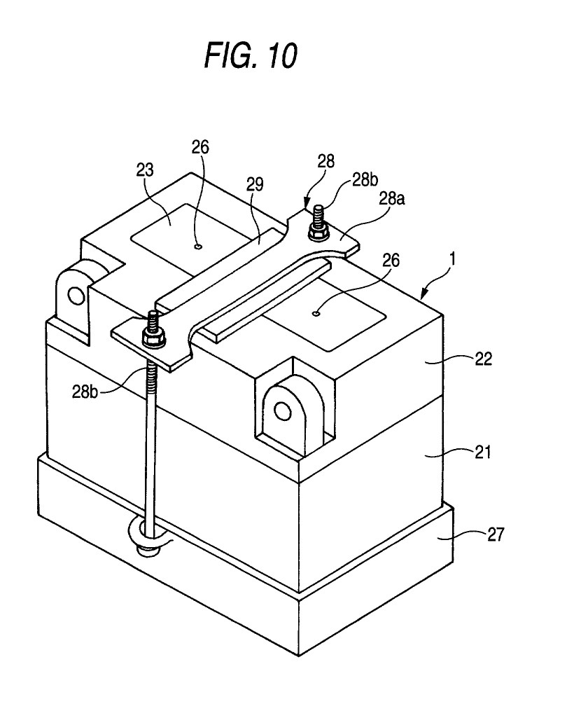

FIG. 8A is a partially enlarged longitudinal section view of the neighboring portion of the exhaust port of the lead acid battery according to the sixth embodiment of the present invention. FIGS. 8B and 8C are modifications of the neighboring portion of the exhaust port shown in FIG. 8A. In FIGS. 8B and 8C, a filter 30 is disposed on an inside of the inner lid 22 so as to seal the exhaust port 26. The filter 30 leads the inside air of the lead acid battery, while the filter 30 prevents an outside dust or the like from invading into the lead acid battery.

As has been described heretofore in detail, according to the lead acid battery of the present invention, due to formation of the projections in the periphery of the exhaust port, even in case where the exhaust port is covered with a certain part, there can be secured an exhaust passage for the gas, which eliminates the possibility that the gas can stay in the interior of the lead acid battery. Or, in case where the exhaust port is opened up in the groove cut formed in the surface of the lead acid battery, the exhaust port can be prevented from being closed and the groove provide an exhaust passage, so that the gas generated and collecting in the interior of the lead acid battery can be effectively discharged therefrom.

By the way, in the case of the above described embodiments of the present invention, any one of them can be enforced in combination with one or more of the remaining embodiments. Also, although the exhaust port, control valve unit and groove are disposed in the top surface of the cover portion of the lead acid battery, they may also be disposed in the side surfaces of the cover portion.

What is claimed is:

1. A lead acid battery comprising:
a container;
a cover including an exhaust port; and
a projection disposed in a peripheral portion of the exhaust port,
wherein the exhaust port is formed in an upper surface or a side surface of the cover.

2. The lead acid battery as set forth in claim 1, wherein the projection includes a plurality of projections, the mutually adjoining ones thereof defining a recessed portion therebetween, and the exhaust port is formed in the recessed portion.

3. The lead acid battery as set forth in claim 1, wherein a groove is formed so as to adjoin the projection.

4. The lead acid battery as set forth in claim 2, wherein a groove is formed so as to adjoin the projections.

5. The lead acid battery as set forth in claim 1, wherein the cover comprises:
an inner lid having a control valve unit; and,
an upper lid covering the control valve unit,
wherein the control valve unit is disposed on a top surface or side surface of the inner lid and, the projection is disposed in the peripheral portion of the exhaust port.

6. The lead acid battery as set forth in claim 5, wherein the projection includes a plurality of projections, the mutually adjoining ones thereof defining a recessed portion therebetween, and the exhaust port is formed in the recessed portion.

7. The lead acid battery as set forth in claim 5, wherein a groove is formed so as to adjoin the projection.

8. The lead acid battery as set forth in claim 6, wherein a groove is formed so as to adjoin the projections.

9. The lead acid battery as set forth in claim 1, wherein the exhaust port and a first groove continuously connected with the exhaust port are formed in the cover, the first groove is formed in the top surface or side surface of the cover, and the exhaust port is formed in the first groove.

10. The lead acid battery as set forth in claim 9, wherein, a second groove is formed in the cover so as to intersect the first groove.

11. The lead acid battery as set forth in claim 10, wherein at least one end of the second groove reaches the end face of the cover.

12. The lead acid battery as set forth in claim 5, wherein the surface of the inner lid adjoining the upper lid forms a first groove therein by cooperating with the upper lid, and the exhaust port is formed in the first groove.

13. The lead acid battery as set forth in claim 12, wherein a second groove is formed in the cover so as to intersect the first groove.

14. The lead acid battery as set forth in claim 13, wherein at least one end of the second groove reaches the end face of the cover.

15. The lead acid battery comprising:
a container; and,
a cover including an exhaust port,
wherein a first groove continuously connected with the exhaust port is formed in the top surface or side surface of the cover and the exhaust port is formed in the first groove.

16. The lead acid battery as set forth in claim 15, wherein, a second groove is formed in the cover so as to intersect the first groove.

17. The lead acid battery as set forth in claim 16, wherein at least one end of the second groove reaches the end face of the cover.

18. The lead acid battery as set forth in claim 15, wherein the cover comprises:
an inner lid having a control valve unit; and,
an upper lid covering the control valve,
wherein, the surface of the inner lid adjoining the upper lid is formed the first groove therein by cooperating with the upper lid and the exhaust port is formed in the first groove.

19. The lead acid battery as set forth in claim 18, wherein a second groove is formed in the cover so as to intersect the first groove.

20. The lead acid battery as set forth in claim 19, wherein at least one end of the second groove reaches the end face of the cover.
